(19) United States
(12) Patent Application Publication
(10) Pub. No.: US 2016/0282664 A1
(43) Pub. Date: Sep. 29, 2016

(54) CURVED DISPLAY PANEL AND CURVED DISPLAY DEVICE

(71) Applicant: SHENZHEN CHINA STAR OPTOELECTRONICS TECHNOLOGY CO., LTD., Guangdong (CN)

(72) Inventor: Chuan Wu, Guangdong (CN)

(21) Appl. No.: 14/408,105

(22) PCT Filed: Nov. 7, 2014
(86) PCT No.: PCT/CN2014/090548

§ 371 Date: Dec. 15, 2014

(30) Foreign Application Priority Data
Nov. 3, 2014 (CN) 201410613764.8

(51) Int. Cl. G02F 1/1335; G02F 1/1343; G02F 1/1362; G02F 1/1368

(52) U.S. Cl. CPC G02F 1/133512; G02F 1/1368; G02F 1/134309; G02F 1/133514; G02F 1/136286; G02F 2201/50; G02F 2201/56

(57) ABSTRACT

A curved display panel and a curved display device curved display panel are provided. The curved display panel includes a color filter substrate, a liquid crystal layer, and a thin film transistor array substrate. The color filter substrate includes a first substrate, a color resist array layer, a black matrix layer, a first protective layer, and a common electrode. The thin film transistor array substrate includes a second substrate and a pixel array layer. Light leakage from the curved display panel can be effectively prevented.

### FIELD OF THE INVENTION

The present invention relates to a field of display technique, and particularly to a curved display panel and a curved display device.

### BACKGROUND OF THE INVENTION

A conventional curved display device is usually formed by bending a conventional flat display device, which comprises a thin film transistor array substrate 101, a liquid crystal layer 1002, and a color filter substrate 103.

As shown in FIG. 1, in the process of manufacturing the conventional curved display device, since a panel center serves as a base for the thin film transistor array substrate 101 and the color filter substrate 103, relative shifts will gradually occur in a horizontal direction toward to the right and the left (104, 105) sides. As shown in FIG. 2 and FIG. 3, a relative shift between a black matrix strip 302 in the color filter substrate 103 and a data line 201 in the thin film transistor array substrate 101 occurs accordingly, so that a light leakage region 301 appears in the curved display device. Moreover, V-crosstalk occurs on the whole curved surface of the curved display device.

Therefore, it is necessary to provide a new technical solution to solve the above technical problems.

### SUMMARY OF THE INVENTION

An object of the present invention is to provide a curved display panel and a curved display device, which can effectively prevent light leakage caused by a region of the curved display panel being unshielded by the black matrix layer.

In order to solve the above-mentioned problem, the technical solution of the present invention is as follows:

A curved display panel, where the curved display panel comprises: a color filter substrate comprising: a first substrate; a color resist array layer disposed on the first substrate; a black matrix layer disposed on the first substrate; a first protective layer disposed on the color resist array layer and the black matrix layer, and a common electrode disposed on the first protective layer; a liquid crystal layer, and a thin film transistor array substrate comprising: a second substrate; and a pixel array layer disposed on the second substrate, the pixel array layer having a pixel unit array, a scan line array, a data line array, and a thin film transistor switch array, where the color filter substrate and the thin film transistor array substrate are aligned and assembled together, the liquid crystal layer is disposed between the color filter substrate and the thin film transistor array substrate; the color filter substrate and the thin film transistor array substrate are assembled as a flat display panel in a planar state, and the curved display panel is obtained by bending the flat display panel; the black matrix layer is formed in a grid shape, each grid of the black matrix layer is composed of at least four sections.

In the above-mentioned curved display panel, the curved display panel comprises at least a first region, a second region, and a third region, the first region is located on a middle of the curved display panel, the second region and the third region are located on outsides of the first region; in a position of the thin film transistor array substrate corresponding to the first region, the data line array comprises at least one first data ins, the pixel unit array comprises at least one first pixel unit and at least one second pixel unit, the first pixel unit is adjacent to the second pixel unit, the first data line is located between the first pixel unit and the second pixel unit, there is a first distance between the first data line and the first pixel unit, and there is a second distance between the first data line and the second pixel unit, a first ratio of the first distance to the second distance is in a range of 50% to 200%; where the first pixel unit is a pixel unit corresponding to the first data line and near the second region, the second pixel unit is a pixel unit corresponding to the first data line and near the third region; in a position of the thin film transistor array substrate corresponding to the second region, the data line array comprises at least one second data line, the pixel unit array comprises at least one third pixel unit and at least one fourth pixel unit, the third pixel unit is adjacent to the fourth pixel unit, the second data line is located between the third pixel unit and the fourth pixel unit, the second data line and the third pixel unit have a third distance, the second data line and the fourth pixel unit have a fourth distance, the third distance is greater than the fourth distance; where the third pixel unit is a pixel unit corresponding to the second data line and away from the second region, the fourth pixel unit is a pixel unit corresponding to the second data line and near the first region; in a position of the thin film transistor array substrate corresponding to the third region, the data line array comprises at least one third data line, the pixel unit array comprises at least one fifth pixel unit and at least one sixth pixel unit, the fifth pixel unit is adjacent to the sixth pixel unit, the third data line is located between the fifth pixel unit and the sixth pixel unit, the third data line and the fifth pixel unit have a fifth distance, the third data line and the sixth pixel unit have a sixth distance, the fifth distance is smaller than the sixth distance; where the fifth pixel unit is a pixel unit corresponding to the third data line and near the first region, the sixth pixel unit is a pixel unit corresponding to the third data line and away from the first region.

In the above-mentioned curved display panel, the black matrix layer comprises a first section in a position corresponding to the first region, a straight line where the first section is located is parallel to a straight line where the first data line is located, a first space between the first pixel unit and the second pixel unit is shielded by the first section; the black matrix layer comprises a second section in a position corresponding to the second region, a straight line where the second section is located is parallel to a straight line where the second data line is located a portion of a second space between the third pixel unit and the fourth pixel unit is shielded by the second section, a location where the second data line is located corresponds to the other portion of the second space; the black matrix layer comprises a third section in a position corresponding to the third region, a straight line where the third section is located is parallel to a straight line where the third data line is located, a portion of a third space between the fifth pixel unit and the sixth pixel unit is shielded by the third section, a location where the third data line is located corresponds to the other portion of the third space.

In the above-mentioned curved display panel, the other portion of the second space is shielded by the second data line, the other portion of the third space is shielded by the third data line.

A curved display panel, the curved display panel comprises: a color filter substrate comprising: a first substrate; a color resist array layer disposed on the first substrate; a black matrix layer disposed on the first substrate; a first protective layer disposed on the color resist array layer and the black matrix layer; and a common electrode disposed on the first protective layer, a liquid crystal layer and a thin film transistor array substrate comprising: a second substrate; and a pixel array layer disposed on the second substrate, the pixel array layer having a pixel unit array, a scan line array, a data line array, and a thin film transistor switch array; where the color filter substrate and the thin film transistor array substrate are aligned and assembled together, the liquid crystal layer is disposed between the color filter substrate and the thin film transistor array substrate.

In the above-mentioned curved display panel, the color filter substrate and the thin film transistor array substrate are assembled as a flat display panel in a planar state, and the curved display panel is obtained by bending the flat display panel.

In the above-mentioned curved display panel, the curved display panel comprises at least a first region, a second region, and a third region, the first region is located on a middle of the curved display panel, the second region and the third region are located on outsides of the first region; in a position of the thin film transistor array substrate corresponding to the first region, the data line array comprises at least one first data line, the pixel unit array comprises at least one first pixel unit and at least one second pixel unit, the first pixel unit is adjacent to the second pixel unit, the first data line is located between the first pixel unit and the second pixel unit, there is a first distance between the first data line and the first pixel unit, there is a second distance between the first data line and the second pixel unit, a first ratio of the first distance to the second distance is in a range of 50% to 200%; where the first pixel unit is a pixel unit corresponding to the first data line and near the second region, the second pixel unit is a pixel unit corresponding to the first data line and near the third region; in a position of the thin film transistor array substrate corresponding to the second region, the data line array comprises at least one second data line, the pixel unit array comprises at least one third pixel unit and at least one fourth pixel unit, the third pixel unit is adjacent to the fourth pixel unit, the second data line is located between the third pixel unit and the fourth pixel unit, the second data line and the third pixel unit have a third distance, the second data line and the fourth pixel unit have a fourth distance, the third distance is greater than the fourth distance; where the third pixel unit is a pixel unit corresponding to the second data line and away from the second region, the fourth pixel unit is a pixel unit corresponding to the second data line and near the first region; in a position of the thin film transistor array substrate corresponding to the third region, the data line array comprises at least one third data line, the pixel unit array comprises at least one fifth pixel unit and at least one sixth pixel unit, the fifth pixel unit is adjacent to the sixth pixel unit, the third data line is located between the fifth pixel unit and the sixth pixel unit, the third data line and the fifth pixel unit have a fifth distance, the third data line and the sixth pixel unit have a sixth distance, the fifth distance is smaller than the sixth distance; where the fifth pixel unit is a pixel unit corresponding to the third data line and near the first region, the sixth pixel unit is a pixel unit corresponding to the third data line and away from the first region.

In the above-mentioned curved display panel, the black matrix layer comprises a first section in a position corresponding to the first region, a straight line where the first section is located is parallel to a straight line where the first data line is located, a first space between the first pixel unit and the second pixel unit is shielded by the first section; the black matrix layer comprises a second section in a position corresponding to the second region, a straight line where the second section is located is parallel to a straight line where the second data line is located a portion of a second space between the third pixel unit and the fourth pixel unit is shielded by the second section, a location where the second data line is located corresponds to the other portion of the second space; the black matrix layer comprises a third section in a position corresponding to the third region, a straight line where the third section is located is parallel to a straight line where the third data line is located, a portion of a third space between the fifth pixel unit and the sixth pixel unit is shielded by the third section, a location where the third data line is located corresponds to the other portion of the third space.

In the above-mentioned curved display panel, the other portion of the second space is shielded by the second data line, the other portion of the third space is shielded by the third data line.

In the above-mentioned curved display panel, a second ratio of the third distance to the fourth distance is in a range of 200% to 2000%, a third ratio of the fifth distance to the sixth distance is in a range of 5% to 50%.

In the above-mentioned curved display panel, a pixel electrode in the pixel unit is a curved electrode.

In the above-mentioned curved display panel, the pixel array layer further comprises at least one shielding electrode. In a first direction, the shielding electrode is located on an up or down direction of the pixel electrode; the first direction is a direction which is along a curvature radius of the pixel unit and from a curved surface where the pixel unit is located to its center.

A curved display device, the curved display device comprises: a curved backlight module; and a curved display panel, the curved display panel is superposed on and assembled with the curved backlight module, the curved display panel comprises: a color filter substrate comprising: a first substrate; a color resist array layer disposed on the first substrate; a black matrix layer disposed on the first substrate; a first protective layer disposed on the color resist array layer and the black matrix layer and a common electrode disposed on the first protective layer; a liquid crystal layer; and a thin film transistor array substrate comprising: a second substrate; and a pixel array layer disposed on the second substrate, the pixel array layer having a pixel unit array, a scan line array, a data line array, and a thin film transistor switch array; where the color filter substrate and the thin film transistor array substrate are aligned and assembled together, the liquid crystal layer is disposed between the color filter substrate and the thin film transistor array substrate.

In the above-mentioned curved display device, the color filler substrate and the thin film transistor array substrate are assembled as a flat display panel in a planar state, and the curved display panel is obtained by bending the flat display panel.

In the above-mentioned curved display device, the curved display panel comprises at least a first region, a second region, and a third region; the first region is located on a middle of the curved display panel, the second region and the third region are located on outsides of the first region. In a position of the thin film transistor array substrate corresponding to the first region, the data line array comprises at least one first data line, the pixel unit array comprises at least one first pixel unit and at least one second pixel unit, the first pixel unit is adjacent to the second pixel unit, the first data line is located between the first pixel unit and the second pixel unit, there is a first distance between the first data line and the first pixel unit, and there is a second distance between the first data line and the second pixel unit, a first ratio of the first distance to the second distance is in a range of 50% to 200%; where the first pixel unit is a pixel unit corresponding to the first data line and near the second region, the second pixel unit is a pixel unit corresponding to the first data line and near the third region; in a position of the thin film transistor array substrate corresponding to the second region, the data line array comprises at least one second data line, the pixel unit array comprises at least one third pixel unit and at least one fourth pixel unit, the third pixel unit is adjacent to the fourth pixel unit, the second data line is located between the third pixel unit and the fourth pixel unit, the second data line and the third pixel unit have a third distance, the second data line and the fourth pixel unit have a fourth distance, the third distance is greater than the fourth distance; where the third pixel unit is a pixel unit corresponding to the second data line and away from the second region, the fourth pixel unit is a pixel unit corresponding to the second data line and near the first region; in a position of the thin fin transistor array substrate corresponding to the third region, the data line array comprises at least one third data line, the pixel unit array comprises at least one fifth pixel unit and at least one sixth pixel unit, the fifth pixel unit is adjacent to the sixth pixel unit, the third data line is located between the fifth pixel unit and the sixth pixel unit, the third data line and the fifth pixel unit have a fifth distance, the third data line and the sixth pixel unit have a sixth distance, the fifth distance is smaller than the sixth distance; where the fifth pixel unit is a pixel unit corresponding to the third data line and near the first region, the sixth pixel unit is a pixel unit corresponding to the third data line and away from the first region.

In the above-mentioned curved display device, the black matrix layer comprises a first section in a position corresponding to the first region, a straight line where the first section is located is parallel to a straight line where the first data line is located, a first space between the first pixel unit and the second pixel unit is shielded by the first section; the black matrix layer comprises a second section in a position corresponding to the second region, a straight line where the second section is located is parallel to a straight line where the second data line is located, a portion of a second space between the third pixel unit and the fourth pixel unit is shielded by the second section, a location where the second data line is located corresponds to the other portion of the second space; the black matrix layer comprises a third section in a position corresponding to the third region, a straight line where the third section is located is parallel to a straight line where the third data line is located, a portion of a third space between the fifth pixel unit and the sixth pixel unit is shielded by the third section, a location where the third data line is located corresponds to the other portion of the third space.

In the above-mentioned curved display device, the other portion of the second space is shielded by the second data line, the other portion of the third space is shielded by the third data line.

In the above-mentioned curved display device, a second ratio of the third distance to the fourth distance is in a range of 200% to 2000%, a third ratio of the fifth distance to the sixth distance is in a range of 5% to 50%.

In the above-mentioned curved display device, a pixel electrode in the pixel unit is a curved electrode.

In the above-mentioned curved display device, the pixel array layer further comprises at least one shielding electrode. In a first direction, the shielding electrode is located on an up or down direction of the pixel electrode, the first direction is a direction which is along a curvature radius of the pixel unit and from a curved surface where the pixel unit is located to its center.

In comparison to the prior art, the present invention can effectively prevent light leakage caused by a region of the curved display panel being unshielded by the black matrix layer.

In order to make the present invention more clear, preferred embodiments, and the drawings thereof, are described in detail below.

### BRIEF DESCRIPTION OF THE DRAWINGS

FIG. 1 shows a schematic diagram of a conventional curved display panel.

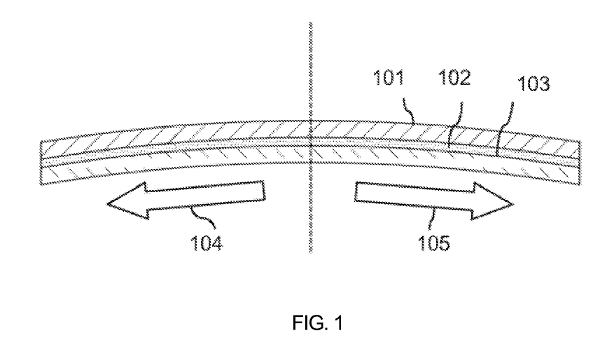

FIG. 2 shows a partial schematic diagram of the curved display panel according to FIG. 1.

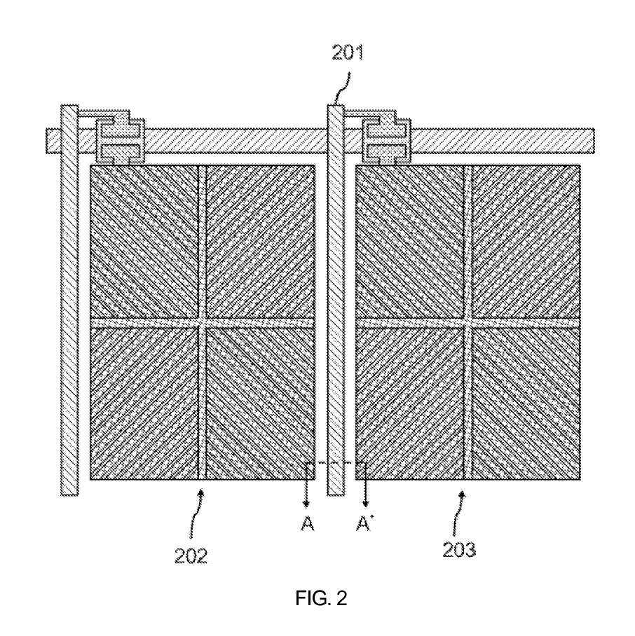

FIG. 3 shows a schematic diagram of section A-A′ according to FIG. 2.

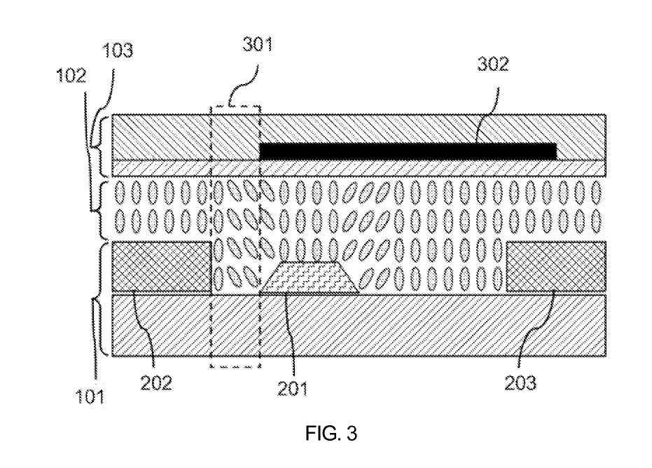

FIG. 4 shows an isometric diagram of a curved display device according to the present invention.

FIG. 5 shows a front view of the curved display panel according to FIG. 4, which is in an unbent state.

FIG. 6 shows a schematic diagram of section B-B′ according to FIG. 5.

FIG. 7 shows a schematic diagram of section C-C′ according to FIG. 5.

FIG. 8 shows a schematic diagram of section D-D′ according to FIG. 5.

FIG. 9 shows a front view of the curved display panel according to FIG. 4.

FIG. 10 shows a schematic diagram of section E-E′ according to FIG. 9.

FIG. 11 shows a schematic diagram of section F-F′ according to FIG. 9.

FIG. 12 shows a schematic diagram of section G-G′ according to FIG. 9.

### DETAILED DESCRIPTION OF THE INVENTION

The term “embodiment” is used herein to mean serving as an example, instance, or illustration. In addition, the articles “a” and “an” as used in this application and the appended claims should generally be construed to mean “one or more” unless specified otherwise or clear from the context to be directed to a singular form.

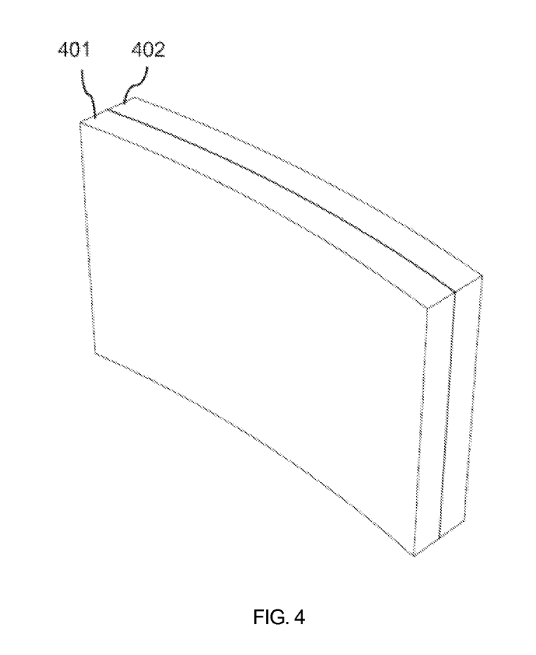

Refer to FIG. 4, which shows an isometric diagram of a curved display device according to the present invention.

In this embodiment, the curved display device comprises a curved backlight module 402 and a curved display panel 401. The curved display panel 401 is superposed on and assembled with the curved backlight module 402.

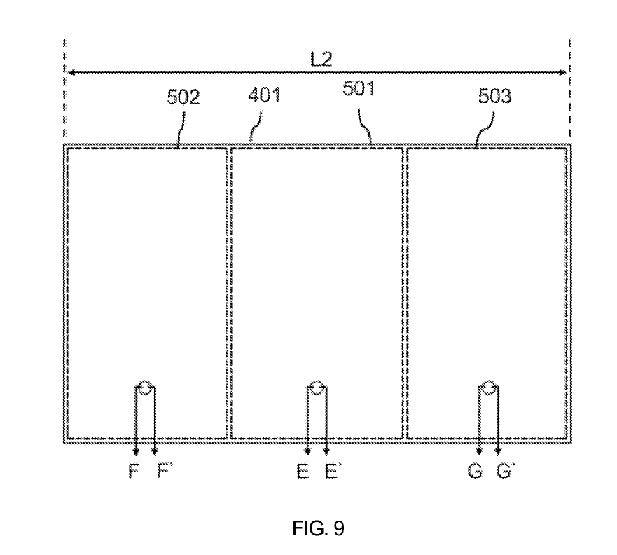

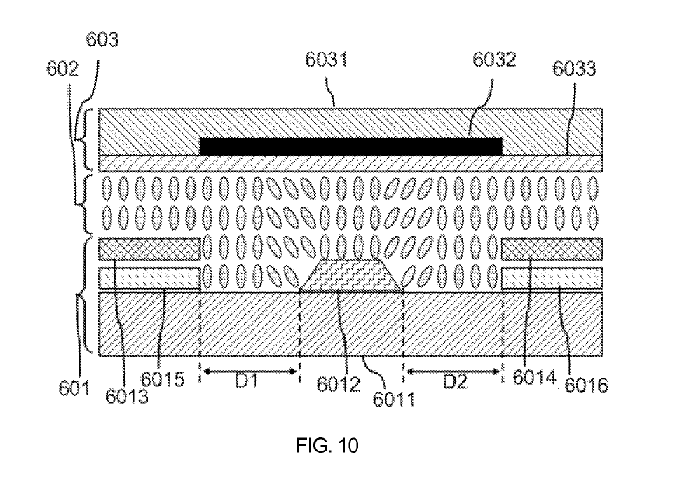

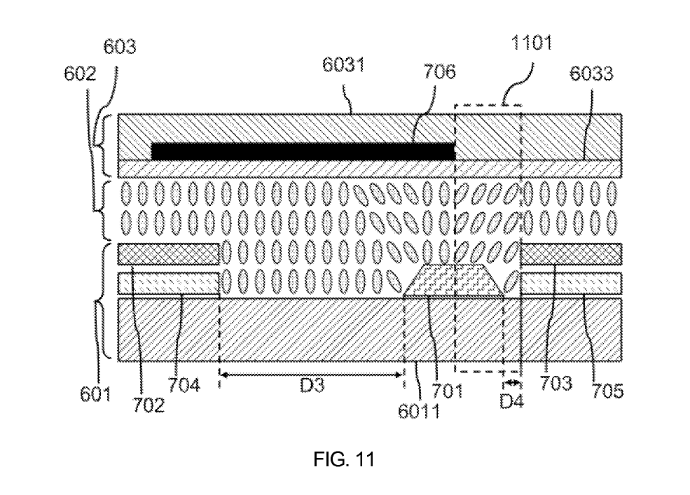

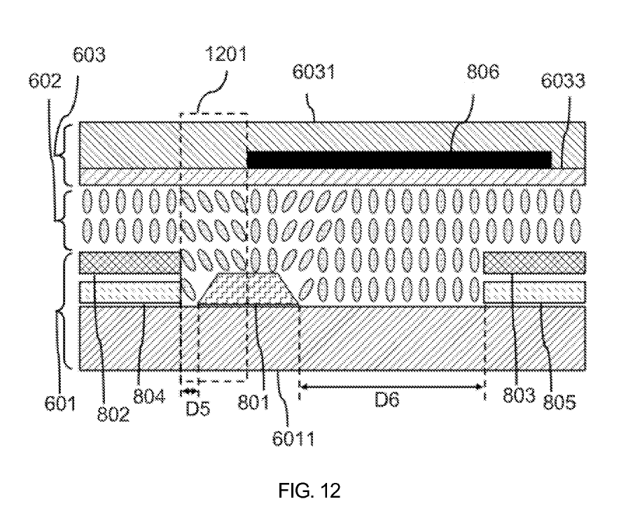

Refer to FIG. 9, FIG. 10, FIG. 11, and FIG. 12, FIG. 9 shows a front view of the curved display panel 401 according to FIG. 4, FIG. 10 shows a schematic diagram of section E-E′ according to FIG. 9, FIG. 11 shows a schematic diagram of section F-F′ according to FIG. 9, and FIG. 12 shows a schematic diagram of section G-G′ according to FIG. 9.

The curved display panel 401 comprises a color filter substrate 603, a liquid crystal layer 602, and a thin film transistor array substrate 601, where the color filter substrate 603 and the thin film transistor array substrate 601 are aligned and assembled together. The liquid crystal layer 602 is disposed between the color filter substrate 603 and the thin film transistor array substrate 601.

The color filter substrate 603 comprises a first substrate 6031, a color resist array layer, a black matrix layer, a first protective layer, and a common electrode 6033. The color resist array layer (not shown in the Figures) is disposed on the first substrate 6031, the black matrix layer is disposed on the first substrate 6031, and the first protective layer is disposed on the color resist array layer and the black matrix layer. The black matrix layer is formed in a grid shape, and each grid of the black matrix layer is composed of at least four sections. Specifically, the grid is formed by connecting end-to-end four sections. The color resist unit is disposed in the grid.

The thin film transistor array substrate 601 comprises a second substrate 6011 and a pixel array layer. The pixel array layer is disposed on the second substrate 6011. The pixel array layer has a pixel unit array, a scan line array, a data line array, and a thin film transistor switch array.

In this embodiment, the color filler substrate 603 and the thin film transistor array substrate 601 are assembled as a flat display panel in a planar state, and the curved display panel 401 is obtained by bending the flat display panel.

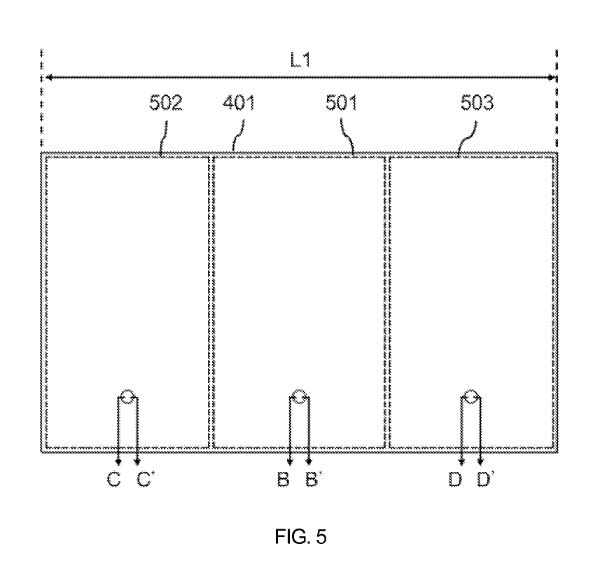

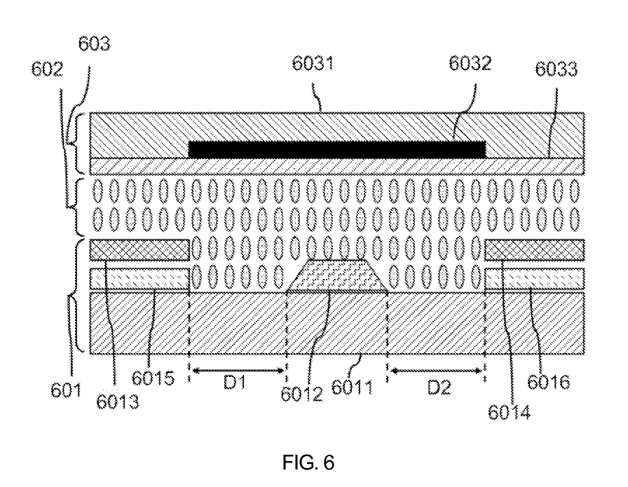

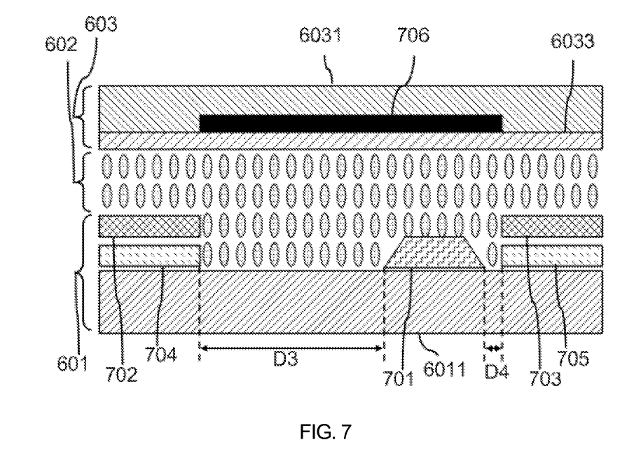

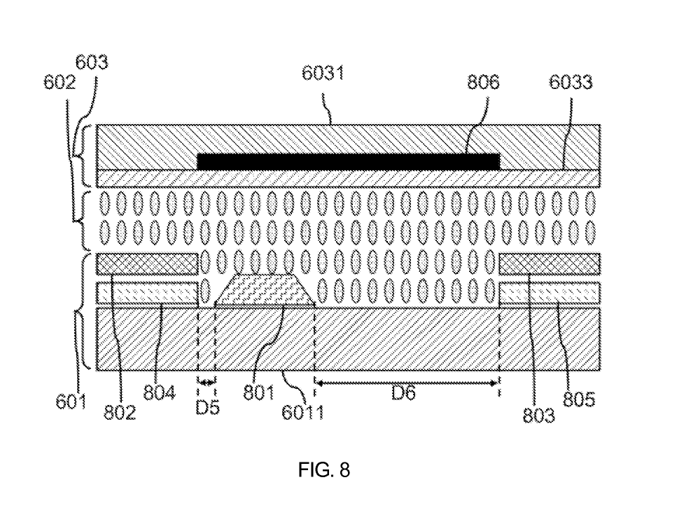

In an unbent state, the curved display panel is as shown in FIG. 5, FIG. 6, FIG. 7, and FIG. 8. The curved display panel is as shown in FIG. 9, FIG. 10, FIG. 11, and FIG. 12.

When the curved display panel in a planar state (before bending), it has a first length L1 in the long side direction. When in a bending state, it has a second length L2 in the long side direction, where L1 is greater than L2.

In this embodiment, the curved display panel 401 comprises at least a first region 501, a second region 502, and a third region 503. The first region 501 is located on the middle of the curved display panel 401, and the second region 502 and the third region 503 are located on outsides of the first region 501.

In a position of the thin film transistor array substrate 601 corresponding to the first region 501, the data line array comprises at least one first data line 6012, the pixel unit array comprises at least one first pixel unit 6013 and at least one second pixel unit 6014. The first pixel unit 6013 is adjacent to the second pixel unit 6014. The first data line 6012 is located between the first pixel unit 6013 and the second pixel unit 6014. There is A first distance D1 between the first data line 6012 and the first pixel unit 6013. There is a second distance D2 is between the first data lne 6012 and the second pixel unit 6014. The first pixel unit 6013 is a pixel unit corresponding to the first data line 6012 and near the second region 502. The second pixel unit 6014 is a pixel unit corresponding to the first data line 6012 and near the third region 503.

A first ratio of the first distance D1 to the second distance D2 is in a range of 50% to 200%; for example, the value of the first ratio is 50%, 55%, 60%, 65%, 70%, 75%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, or 200%. Preferably, the first distance D1 is equal to second distance D2. That is, the value of the first ratio is 100%.

In a position of the thin film transistor array substrate 601 corresponding to the second region 502, the data line array comprises at least one second data line 701, and the pixel unit array comprises at least one third pixel unit 702 and at least one fourth pixel unit 703. The third pixel unit 702 is adjacent to the fourth pixel unit 703. The second data line 701 is located between the third pixel unit 702 and the fourth pixel unit 703. The second data line 701 and the third pixel unit 702 have a third distance D3. The second data line 701 and the fourth pixel unit 703 have a fourth distance D4. The third pixel unit 702 is a pixel unit corresponding to the second data line 701 and away from the second region 501. The fourth pixel unit 703 is a pixel unit corresponding to the second data line 701 and near the first region 501.

The third distance D3 is greater than the fourth distance D4. Specifically, a second ratio of the third distance D3 to the fourth distance D4 is in a range of 200% to 2000%; for example, the value of the second ratio is 200%, 250%, 300%, 350%, 400%, 450%, 500%, 550%, 600%, 700%, 750%, 800%, 850%, 900%, 950%, 1000%, 1100%, 1200%, 1300%, 1400%, 1500%, 1600%, 1700%, 1800%, 1900%, or 2000%.

In a position of the thin film transistor array substrate 601 corresponding to the third region 503, the data line array comprises at least one third data line 801, and the pixel unit array comprises at least one fifth pixel unit 802 and at least one sixth pixel unit 803. The fifth pixel unit 802 is adjacent to the sixth pixel unit 803. The third data line 801 is located between the fifth pixel unit 802 and the sixth pixel unit 803. The third data line 801 and the fifth pixel unit 802 have a fifth distance D5. The third data line 801 and the sixth pixel unit 803 have a sixth distance D6. The fifth pixel unit 802 is a pixel unit corresponding to the third data line 801 and near the first region 501, the sixth pixel unit 803 is a pixel unit corresponding to the third data line 801 and away from the first region 501.

The fifth distance D5 is smaller than the sixth distance D6. Specifically, a third ratio of the fifth distance D5 to the sixth distance D6 is in a range of 5% to 50%; for example, the value of the second ratio is 5%, 6%, 7%, 8%, 9%, 10%, 12%, 15%, 18%, 20%, 24%, 29%, 33%, 39%, 45%, or 50%.

In this embodiment, the values of the third distance and the sixth distance may between 0 and 1 um (micrometers).

In this embodiment, the black matrix layer comprises a first section 6032 in a position corresponding to the first region 501. A straight line where the first section 6032 is located is parallel to a straight line where the first data line 6012 is located. A first space between the first pixel unit 6013 and the second pixel unit 6014 is shielded by the first section 6032.

The black matrix layer comprises a second section 706 in a position corresponding to the second region 502. A straight line where the second section 706 is located is parallel to a straight line where the second data line 701 is located. A portion of a second space between the third pixel unit 702 and the fourth pixel unit 703 is shielded by the second section 706. A location where the second data line 701 is located corresponds to the other portion of the second space.

The black matrix layer comprises a third section 806 in a position corresponding to the third region 503. A straight line where the third section 806 is located is parallel to a straight line where the third data line 801 is located. A portion of a third space between the filth pixel unit 802 and the sixth pixel unit 803 is shielded by the third section 806. A location where the third data line 801 is located corresponds to the other portion of the third space.

In this embodiment, the other portion of the second space is shielded by the second data line 701, and the other portion of the third space is shielded by the third data line 801. That is, the width of the second data line 701 is greater than or equal to the width of the other portion of the second space. The width of the third data line 801 is greater than or equal to the width of the other portion of the third space.

As shown in FIG. 11, the location of the second data line 701 corresponds to a region which is not shielded by the second section 706 of the black matrix layer in the second space. Therefore, the above-mentioned technical solution can effectively prevent light leakage caused by a region 1101 being unshielded by the second section 706 of the black matrix layer. Similarly, as shown in FIG. 12, the location of the third data line corresponds to a region which is not shielded by the third section 806 of the black matrix layer in the third space. Therefore, the above-mentioned technical solution can effectively prevent light leakage caused by a region 1201 being unshielded by the third section 806 of the black matrix layer.

Moreover, a V-crosstalk problem of the curved display panel in the curved state can be solved without changing an aperture ration by the above-mentioned technical solutions.

A pixel electrode in the pixel unit is a curved electrode.

In this embodiment, the pixel array layer further comprises at least one shielding electrode (6015, 6016, 704, 705, 804, 805). In a first direction, the shielding electrode (6015, 6016, 704, 705, 804, 805) and the pixel electrode are respectively located on different layers. The first direction is along a curvature radius of the pixel unit and from a curved surface where the pixel unit is located to its center. For example, the shielding electrode (6015, 6016, 704, 705, 804, 805) is located on the up or down direction of the pixel electrode.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular, with regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such a feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

The above descriptions are merely preferable embodiments of the present invention, but are not intended to limit the scope of the present invention. Any modification or replacement made by those skilled in the art without departing from the spirit and principle of the present invention should fall within the protection scope of the present invention. Therefore, the protection scope of the present invention is subject to the appended claims.

1. A curved display panel, wherein the curved display panel comprises:
a color filter substrate comprising:
a first substrate;
a color resist array layer disposed on the first substrate;
a black matrix layer disposed on the first substrate;
a first protective layer disposed on the color resist array layer and the black matrix layer; and
a common electrode disposed on the first protective layer;
a liquid crystal layer; and
a thin film transistor array substrate comprising:
a second substrate; and
a pixel array layer disposed on the second substrate, the pixel array layer having a pixel unit array, a scan line array, a data line array, and a thin film transistor switch array;
wherein the color filter substrate and the thin film transistor array substrate are aligned and assembled together, the liquid crystal layer is disposed between the color filter substrate and the thin film transistor array substrate;
the color filter substrate and the thin film transistor array substrate are assembled as a flat display panel in a planar state, and the curved display panel is obtained by bending the flat display panel;
the black matrix layer is formed in a grid shape, each grid of the black matrix layer is composed of at least four sections.

2. The curved display panel according to claim 1, wherein the curved display panel comprises at least a first region, a second region, and a third region, the first region is located on a middle of the curved display panel, the second region and the third region are located on outsides of the first region;
in a position of the thin film transistor array substrate corresponding to the first region, the data line array comprises at least one first data line, the pixel unit array comprises at least one first pixel unit and at least one second pixel unit, the first pixel unit is adjacent to the second pixel unit, the first data line is located between the first pixel unit and the second pixel unit, there is a first distance between the first data line and the first pixel unit, and there is a second distance between the first data line and the second pixel unit, a first ratio of the first distance to the second distance is in a range of 50% to 200%;
wherein the first pixel unit is a pixel unit corresponding to the first data line and near the second region, the second pixel unit is a pixel unit corresponding to the first data line and near the third region;
in a position of the thin film transistor array substrate corresponding to the second region, the data line array comprises at least one second data line, the pixel unit array comprises at least one third pixel unit and at least one fourth pixel unit, the third pixel unit is adjacent to the fourth pixel unit, the second data line is located between the third pixel unit and the fourth pixel unit, the second data line and the third pixel unit have a third distance, the second data line and the fourth pixel unit have a fourth distance, the third distance is greater than the fourth distance;
wherein the third pixel unit is a pixel unit corresponding to the second data line and away from the second region, the fourth pixel unit is a pixel unit corresponding to the second data line and near the first region;
in a position of the thin film transistor array substrate corresponding to the third region, the data line array comprises at least one third data line, the pixel unit array comprises at least one fifth pixel unit and at least one sixth pixel unit, the fifth pixel unit is adjacent to the sixth pixel unit, the third data line is located between the fifth pixel unit and the sixth pixel unit, the third data line and the fifth pixel unit have a fifth distance, the third data line and the sixth pixel unit have a sixth distance, the fifth distance is smaller than the sixth distance;
wherein the fifth pixel unit is a pixel unit corresponding to the third data line and near the first region, the sixth pixel unit is a pixel unit corresponding to the third data line and away from the first region.

3. The curved display panel according to claim 2, wherein the black matrix layer comprises a first section in a position corresponding to the first region, a straight line where the first section is located is parallel to a straight line where the first data line is located, a first space between the first pixel unit and the second pixel unit is shielded by the first section;
the black matrix layer comprises a second section in a position corresponding to the second region, a straight line where the second section is located is parallel to a straight line where the second data line is located, a portion of a second space between the third pixel unit and the fourth pixel unit is shielded by the second section, a location where the second data line is located corresponds to other portion of the second space;
the black matrix layer comprises a third section in a position corresponding to the third region, a straight line where the third section is located is parallel to a straight line where the third data line is located, a portion of a third space between the fifth pixel unit and the sixth pixel unit is shielded by the third section, a location where the third data line is located corresponds to the other portion of the third space.

4. The curved display panel according to claim 3, wherein the other portion of the second space is shielded by the second data line, the other portion of the third space is shielded by the third data line.

5. A curved display panel, wherein the curved display panel comprises:
a color filter substrate comprising:
a first substrate;
a color resist array layer disposed on the first substrate;
a black matrix layer disposed on the first substrate;
a first protective layer disposed on the color resist array layer and the black matrix layer; and
a common electrode disposed on the first protective layer;
a liquid crystal layer; and
a thin film transistor array substrate comprising:
a second substrate; and
a pixel array layer disposed on the second substrate, the pixel array layer having a pixel unit array, a scan line array, a data line array, and a thin film transistor switch array;
wherein the color filter substrate and the thin film transistor array substrate are aligned and assembled together, the liquid crystal layer is disposed between the color filter substrate and the thin film transistor array substrate.

6. The curved display panel according to claim 5, wherein the color filter substrate and the thin film transistor array substrate are assembled as a flat display panel in a planar state, and the curved display panel is obtained by bending the flat display panel.

7. The curved display panel according to claim 5, wherein the curved display panel comprises at least a first region, a second region, and a third region, the first region is located on a middle of the curved display panel, the second region and the third region are located on outsides of the first region;
in a position of the thin film transistor array substrate corresponding to the first region, the data line array comprises at least one first data line, the pixel unit array comprises at least one first pixel unit and at least one second pixel unit, the first pixel unit is adjacent to the second pixel unit, the first data line is located between the first pixel unit and the second pixel unit, there is a first distance between the first data line and the first pixel unit, and there is a second distance between the first data line and the second pixel unit, a first ratio of the first distance to the second distance is in a range of 50% to 200%;
wherein the first pixel unit is a pixel unit corresponding to the first data line and near the second region, the second pixel unit is a pixel unit corresponding to the first data line and near the third region;
in a position of the thin film transistor array substrate corresponding to the second region, the data line array comprises at least one second data line, the pixel unit array comprises at least one third pixel unit and at least one fourth pixel unit, the third pixel unit is adjacent to the fourth pixel unit, the second data line is located between the third pixel unit and the fourth pixel unit, the second data line and the third pixel unit have a third distance, the second data line and the fourth pixel unit have a fourth distance, the third distance is greater than the fourth distance;
wherein the third pixel unit is a pixel unit corresponding to the second data line and away from the second region, the fourth pixel unit is a pixel unit corresponding to the second data line and near the first region;
in a position of the thin film transistor array substrate corresponding to the third region, the data line array comprises at least one third data line, the pixel unit array comprises at least one fifth pixel unit and at least one sixth pixel unit, the fifth pixel unit is adjacent to the sixth pixel unit, the third data line is located between the fifth pixel unit and the sixth pixel unit, the third data line and the fifth pixel unit have a fifth distance, the third data line and the sixth pixel unit have a sixth distance, the fifth distance is smaller than the sixth distance;
wherein the fifth pixel unit is a pixel unit corresponding to the third data line and near the first region, the sixth pixel unit is a pixel unit corresponding to the third data line and away from the first region.

8. The curved display panel according to claim 7, wherein the black matrix layer comprises a first section in a position corresponding to the first region, a straight line where the first section is located is parallel to a straight line where the first data line is located, a first space between the first pixel unit and the second pixel unit is shielded by the first section;
the black matrix layer comprises a second section in a position corresponding to the second region, a straight line where the second section is located is parallel to a straight line where the second data line is located, a portion of a second space between the third pixel unit and the fourth pixel unit is shielded by the second section, a location where the second data line is located corresponds to the other portion of the second space;
the black matrix layer comprises a third section in a position corresponding to the third region, a straight line where the third section is located is parallel to a straight line where the third data line is located, a portion of a third space between the fifth pixel unit and the sixth pixel unit is shielded by the third section, a location where the third data line is located corresponds to the other portion of the third space.

9. The curved display panel according to claim 8, wherein the other portion of the second space is shielded by the second data line, the other portion of the third space is shielded by the third data line.

10. The curved display panel according to claim 7, wherein a second ratio of the third distance to the fourth distance is in a range of 200% to 2000%, a third ratio of the fifth distance to the sixth distance is in a range of 5% to 50%.

11. The curved display panel according to claim 7, wherein a pixel electrode in the pixel unit is a curved electrode.

12. The curved display panel according to claim 11, wherein the pixel array layer further comprises at least one shielding electrode, in a first direction, the shielding electrode is located on an up or down direction of the pixel electrode, the first direction is a direction which is along a curvature radius of the pixel unit and from a curved surface where the pixel unit is located to its center.

13. A curved display device, wherein the curved display device comprises:
a curved backlight module; and
a curved display panel, the curved display panel is superposed on and assembled with the curved backlight module, the curved display panel comprises:
a color filter substrate comprising:
a first substrate;
a color resist array layer disposed on the first substrate;
a black matrix layer disposed on the first substrate;
a first protective layer disposed on the color resist array layer and the black matrix layer; and
a common electrode disposed on the first protective layer;
a liquid crystal layer; and
a thin film transistor array substrate comprising:
a second substrate; and
a pixel array layer disposed on the second substrate, the pixel array layer having a pixel unit array, a scan line array, a data line array, and a thin film transistor switch array;
wherein the color filter substrate and the thin film transistor array substrate are aligned and assembled together, the liquid crystal layer is disposed between the color filter substrate and the thin film transistor array substrate.

14. The curved display device according to claim 13, wherein the color filter substrate and the thin film transistor array substrate are assembled as a flat display panel in a planar state, and the curved display panel is obtained by bending the flat display panel.

15. The curved display device according to claim 13, wherein the curved display panel comprises at least a first region, a second region, and a third region, the first region is located on a middle of the curved display panel, the second region and the third region are located on outsides of the first region;
in a position of the thin film transistor array substrate corresponding to the first region, the data line array comprises at least one first data line, the pixel unit array comprises at least one first pixel unit and at least one second pixel unit, the first pixel unit is adjacent to the second pixel unit, the first data line is located between the first pixel unit and the second pixel unit, there is a first distance between the first data line and the first pixel unit, and there is a second distance between the first data line and the second pixel unit, a first ratio of the first distance to the second distance is in a range of 50% to 200%;
wherein the first pixel unit is a pixel unit corresponding to the first data line and near the second region, the second pixel unit is a pixel unit corresponding to the first data line and near the third region;
in a position of the thin film transistor array substrate corresponding to the second region, the data line array comprises at least one second data line, the pixel unit array comprises at least one third pixel unit and at least one fourth pixel unit, the third pixel unit is adjacent to the fourth pixel unit, the second data line is located between the third pixel unit and the fourth pixel unit, the second data line and the third pixel unit have a third distance, the second data line and the fourth pixel unit have a fourth distance, the third distance is greater than the fourth distance;
wherein the third pixel unit is a pixel unit corresponding to the second data line and away from the second region, the fourth pixel unit is a pixel unit corresponding to the second data line and near the first region;
in a position of the thin film transistor array substrate corresponding to the third region, the data line array comprises at least one third data line, the pixel unit array comprises at least one fifth pixel unit and at least one sixth pixel unit, the fifth pixel unit is adjacent to the sixth pixel unit, the third data line is located between the fifth pixel unit and the sixth pixel unit, the third data line and the fifth pixel unit have a fifth distance, the third data line and the sixth pixel unit have a sixth distance, the fifth distance is smaller than the sixth distance;
wherein the fifth pixel unit is a pixel unit corresponding to the third data line and near the first region, the sixth pixel unit is a pixel unit corresponding to the third data line and away from the first region.

16. The curved display device according to claim 15, wherein the black matrix layer comprises a first section in a position corresponding to the first region, a straight line where the first section is located is parallel to a straight line where the first data line is located, a first space between the first pixel unit and the second pixel unit is shielded by the first section;
the black matrix layer comprises a second section in a position corresponding to the second region, a straight line where the second section is located is parallel to a straight line where the second data line is located, a portion of a second space between the third pixel unit and the fourth pixel unit is shielded by the second section, a location where the second data line is located corresponds to the other portion of the second space;
the black matrix layer comprises a third section in a position corresponding to the third region, a straight line where the third section is located is parallel to a straight line where the third data line is located, a portion of a third space between the fifth pixel unit and the sixth pixel unit is shielded by the third section, a location where the third data line is located corresponds to the other portion of the third space.

17. The curved display device according to claim 16, wherein the other portion of the second space is shielded by the second data line, the other portion of the third space is shielded by the third data line.

18. The curved display device according to claim 15, wherein a second ratio of the third distance to the fourth distance is in a range of 200% to 2000%, a third ratio of the fifth distance to the sixth distance is in a range of 5% to 50%.

19. The curved display device according to claim 15, wherein a pixel electrode in the pixel unit is a curved electrode.

20. The curved display device according to claim 19, wherein the pixel array layer further comprises at least one shielding electrode, in a first direction, the shielding electrode is located on an up or down direction of the pixel electrode, the first direction is a direction which is along a curvature radius of the pixel unit and from a curved surface where the pixel unit located to its center.
